(19) United States
(12) Patent Application Publication
(10) Pub. No.: US 2025/0196189 A1
(43) Pub. Date: Jun. 19, 2025

(54) TACTILE SENSATION PRESENTING ELEMENT AND TACTILE SENSATION PRESENTING DEVICE

(71) Applicant: Sharp Display Technology Corporation, Kameyama City (JP)

(72) Inventors: Tomonori YOSHIDA, Kameyama City (JP); Takayuki YANAGAWA, Kameyama City (JP); Yasuhiro SUGITA, Kameyama City (JP); Masafumi UENO, Kameyama City (JP); Takuma YAMAMOTO, Kameyama City (JP)

(21) Appl. No.: 18/952,037

(22) Filed: Nov. 19, 2024

(30) Foreign Application Priority Data
Dec. 14, 2023 (JP) 2023-211528

(51) Int. Cl. B06B 1/06; G08B 6/00

(52) U.S. Cl. CPC B06B 1/0692; G08B 6/00

(57) ABSTRACT

A tactile sensation presenting element includes: a vibrator layer; and a first electrode layer and a second electrode layer located so as to oppose each other with the vibrator layer interposed therebetween. At least one of the first electrode layer and the second electrode layer includes a plurality of electrodes that are electrically independent of one another. The vibrator layer includes a plurality of unit regions, in each of which occurrence of vibration can be independently controlled. The tactile sensation presenting element further includes a plurality of protrusions located opposite to the vibrator layer relative to the first electrode layer.

### BACKGROUND

### 1. Technical Field

The present invention relates to tactile sensation presenting elements and particularly to tactile sensation presenting elements configured to present tactile sensations by vibrational stimulation. The present invention also relates to tactile sensation presenting devices including such tactile sensation presenting elements.

### 2. Description of the Related Art

In recent years, tactile sensation presenting elements capable of presenting tactile sensations to a user (also referred to as “haptics devices”) have been receiving attention and have already been applied to a variety of uses, such as medical, educational, entertainment, and remote operation uses. Several types of tactile sensation presenting elements have been known.

A type of tactile sensation presenting element that is configured to present tactile sensations by transmitting vibration to a user, i.e., vibrational stimulation, (hereinafter, referred to as “vibration type”) is one of the most promising types because of small individual differences in tactile sensitivity and high safety. A vibration type tactile sensation presenting element is disclosed in, for example, Japanese Laid-Open Patent Publication No. 2012-128499.

The vibration type tactile sensation presenting element presents tactile sensations by generating vibration by an actuator (e.g., piezoelectric element) while a specific portion of the human body (e.g., finger) is in contact with the tactile sensation presenting element. However, there is such a problem that a user senses a vibration at a portion far away more than the distance between a portion at which the vibration is actually generated and the specific portion. Also, there is such a problem that a user senses a vibration in a broader area than the portion at which the vibration is actually generated. Thus, the vibration type tactile sensation presenting element has difficulty in accurately presenting tactile sensations in minute regions.

Embodiments of the present invention were conceived in view of the above-described problems and are directed to providing vibration type tactile sensation presenting elements that are capable of accurately presenting tactile sensations in minute regions.

### SUMMARY

This specification discloses tactile sensation presenting elements and tactile sensation presenting devices described in the following items.

### [Item 1]

A tactile sensation presenting element comprising:
a vibrator layer; and
a first electrode layer and a second electrode layer located so as to oppose each other with the vibrator layer interposed therebetween,
wherein at least one of the first electrode layer and the second electrode layer includes a plurality of electrodes that are electrically independent of one another,
the vibrator layer includes a plurality of unit regions, in each of which occurrence of vibration can be independently controlled, and
the tactile sensation presenting element further includes a plurality of protrusions located opposite to the vibrator layer relative to the first electrode layer.

### [Item 2]

The tactile sensation presenting element of Item 1, wherein the plurality of protrusions do not overlap centers of the plurality of unit regions as viewed in plan.

### [Item 3]

The tactile sensation presenting element of Item 1 or 2, wherein the plurality of protrusions includes at least one first protrusion located so as to extend across an outer boundary of at least one of the plurality of unit regions.

### [Item 4]

The tactile sensation presenting element of Item 3, wherein
the at least one first protrusion is a plurality of first protrusions,
each of the plurality of unit regions has a generally rectangular shape as viewed in plan, and
one or more of the plurality of first protrusions extend across each side of each of the plurality of unit regions as viewed in plan.

### [Item 5]

The tactile sensation presenting element of any of Items 1 to 4, further comprising a first substrate located between the first electrode layer and the plurality of protrusions, the first substrate supporting the first electrode layer.

### [Item 6]

The tactile sensation presenting element of any of Items 1 to 5, further comprising a second substrate located opposite to the vibrator layer relative to the second electrode layer, the second substrate supporting the second electrode layer,
wherein a thickness of the second substrate, h [mm], and a Young's modulus of the second substrate, E [GPa], satisfy the relationship of E·h≤1.95.

### [Item 7]

The tactile sensation presenting element of any of Items 1 to 6, wherein
each of the plurality of unit regions has a generally rectangular shape as viewed in plan, and
a height of each of the plurality of protrusions is equal to or greater than twice a length of a shortest one of sides of each of the unit regions as viewed in plan.

### [Item 8]

The tactile sensation presenting element of any of Items 1 to 6, wherein
each of the plurality of unit regions has a generally rectangular shape as viewed in plan, and
a height of each of the plurality of protrusions is equal to or greater than three times a length of a shortest one of sides of each of the unit regions as viewed in plan.

### [Item 9]

The tactile sensation presenting element of any of Items 1 to 8, wherein
a shape of a transverse cross section of each of the plurality of protrusions is substantially constant along a height direction of each protrusion, and
a cross-sectional area of each of the plurality of protrusions, A, and a height of each of the plurality of protrusions, H, satisfy the relationship of HZ (2·A^{0.5})/H.

### [Item 10]

The tactile sensation presenting element of Item 9, wherein a cross-sectional shape of each of the plurality of protrusions is a generally circular shape, a generally elliptical shape, a generally rectangular shape, a generally equilateral triangular shape, or a generally equilateral convex polygonal shape.

### [Item 11]

The tactile sensation presenting element of any of Items 1 to 10, wherein a Young's modulus of each of the plurality of protrusions is equal to or smaller than 20 GPa.

### [Item 12]

The tactile sensation presenting element of any of Items 1 to 11, wherein the plurality of electrodes are a plurality of unit electrodes corresponding to the plurality of unit regions.

### [Item 13]

The tactile sensation presenting element of Item 12, wherein the plurality of unit electrodes are nine or more unit electrodes arrayed in m rows and n columns (m and n are each an integer equal to or greater than 3).

### [Item 14]

The tactile sensation presenting element of any of Items 1 to 11, wherein
each of the first electrode layer and the second electrode layer includes the plurality of electrodes,
the plurality of electrodes included in the first electrode layer are a plurality of first strip electrodes elongated in a predetermined direction, and
the plurality of electrodes included in the second electrode layer are a plurality of second strip electrodes elongated in a direction crossing the predetermined direction.

### [Item 15]

The tactile sensation presenting element of any of Items 1 to 14, further comprising:
a second substrate located opposite to the vibrator layer relative to the second electrode layer, the second substrate supporting the second electrode layer, the second substrate including a first region that overlaps a region including the plurality of unit regions of the vibrator layer as viewed in plan and a second region located outside the first region as viewed in plan; and
a fixing member joined with the second region of the second substrate so as to fix the second region.

### [Item 16]

The tactile sensation presenting element of Item 12 or 13, wherein
the first electrode layer includes the plurality of unit electrodes,
the second electrode layer includes only a single common electrode,
the common electrode includes a first region that overlaps a region including the plurality of unit regions of the vibrator layer as viewed in plan and a second region located outside the first region as viewed in plan, and
the tactile sensation presenting element further includes a fixing member joined with the second region of the common electrode so as to fix the second region.

### [Item 17]

The tactile sensation presenting element of any of Items 1 to 16, wherein the vibrator layer is a piezoelectric layer that is made of a piezoelectric material.

### [Item 18]

The tactile sensation presenting element of Item 17, wherein the piezoelectric layer includes a plurality of portions that are separate from one another.

### [Item 19]

The tactile sensation presenting element of any of Items 1 to 16, wherein the vibrator layer includes an induction coil in each of the plurality of unit regions.

### [Item 20]

The tactile sensation presenting device comprising:
the tactile sensation presenting element as set forth in any of Items 1 to 19; and
a control unit capable of controlling the tactile sensation presenting element.

According to embodiments of the present invention, vibration type tactile sensation presenting elements can be provided which are capable of accurately presenting tactile sensations in minute regions.

### BRIEF DESCRIPTION OF THE DRAWINGS

FIG. 1 is a block diagram schematically showing a tactile sensation presenting device 100 that includes a tactile sensation presenting element 1 according to an embodiment of the present invention.

FIG. 2 is diagram for illustrating a fingertip inner portion fp.

FIG. 3 is a cross-sectional view schematically showing the tactile sensation presenting element 1.

FIG. 4A is a plan view schematically showing the tactile sensation presenting element 1 as viewed from the front side.

FIG. 4B is a plan view schematically showing the tactile sensation presenting element 1, in which the first substrate 40 and the protrusions 50 are not shown.

FIG. 5 is a plan view schematically showing a common electrode (second electrode layer) 30 of the tactile sensation presenting element 1.

FIG. 6 shows an example of the equivalent circuit of the tactile sensation presenting element 1.

FIG. 7 is a cross-sectional view schematically showing a tactile sensation presenting element 901 of Comparative Example.

FIG. 8 is a plan view schematically showing the tactile sensation presenting element 901 as viewed from the front side.

FIG. 9 is a plan view schematically showing the tactile sensation presenting element 901, in which the first substrate 40 is not shown.

FIG. 10 illustrates the mechanism of achieving the effects of the tactile sensation presenting element 1.

FIG. 11 illustrates the tactile sensation presenting element 901 of Comparative Example, which is strongly depressed with a finger F.

FIG. 12A is a cross-sectional view schematically showing an alternative tactile sensation presenting element 1A according to an embodiment of the present invention.

FIG. 12B is a plan view schematically showing the second substrate 70 of the tactile sensation presenting element 1A.

FIG. 13A shows another example of the arrangement of the protrusions 50.

FIG. 13B shows still another example of the arrangement of the protrusions 50.

FIG. 14A shows the result window of a vibration simulation where the thickness h and the Young's modulus E of the second substrate 70 are 0.13 mm and 10 GPa, respectively.

FIG. 14B shows the result window of a vibration simulation where the thickness h and the Young's modulus E of the second substrate 70 are 0.13 mm and 15 GPa, respectively.

FIG. 14C shows the result window of a vibration simulation where the thickness h and the Young's modulus E of the second substrate 70 are 0.13 mm and 18 GPa, respectively.

FIG. 14D shows the result window of a vibration simulation where the thickness h and the Young's modulus E of the second substrate 70 are 0.13 mm and 20 GPa, respectively.

FIG. 15 is a cross-sectional view schematically showing still another tactile sensation presenting element 1B according to an embodiment of the present invention.

FIG. 16 is an exploded perspective view schematically showing the tactile sensation presenting element 1B.

FIG. 17 is a plan view schematically showing the tactile sensation presenting element 1B, in which the first substrate 40 and the protrusions 50 are not shown.

FIG. 18 is an exploded perspective view schematically showing still another tactile sensation presenting element 1C according to an embodiment of the present invention.

FIG. 19 is a cross-sectional view schematically showing a part of the tactile sensation presenting element 1C.

FIG. 20 is a perspective view showing an example of the induction coil 13.

FIG. 21 is a cross-sectional view showing another configuration example of the tactile sensation presenting element 1C.

### DETAILED DESCRIPTION

Hereinafter, embodiments of the present invention are described with reference to the drawings. Note that the present invention is not limited to the embodiments described below.

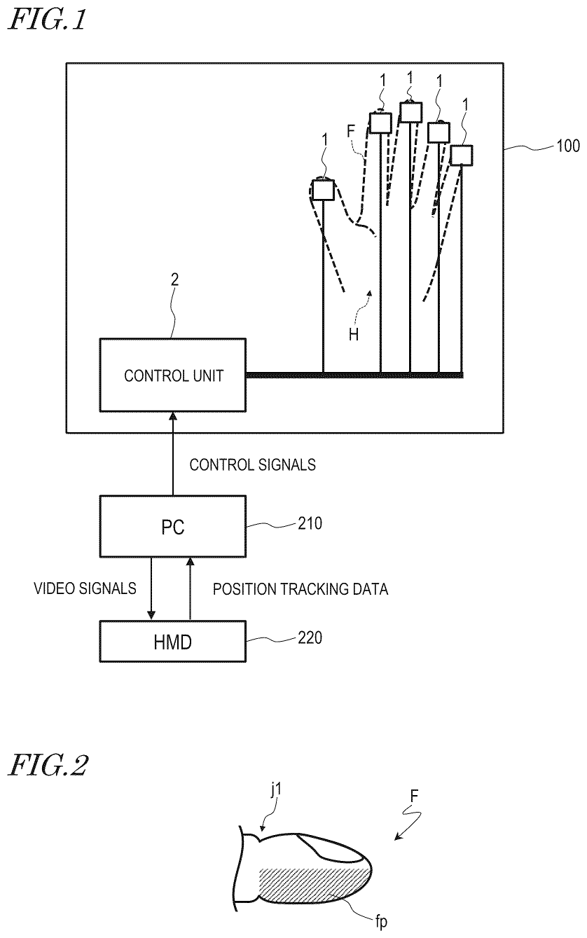

A tactile sensation presenting device 100 that includes a tactile sensation presenting element 1 according to an embodiment of the present invention is described with reference to FIG. 1. FIG. 1 is a block diagram schematically showing the tactile sensation presenting device 100. FIG. 1 also shows a personal computer (PC) 210 and a head mounted display (HMD) 220 in addition to the tactile sensation presenting device 100.

As shown in FIG. 1, the tactile sensation presenting device 100 includes at least one tactile sensation presenting element 1 and a control unit 2 that is capable of controlling the tactile sensation presenting element 1. In the illustrated example, the tactile sensation presenting device 100 includes a plurality of tactile sensation presenting elements 1, more specifically five tactile sensation presenting elements 1. Note that the number of tactile sensation presenting elements 1 is not limited to five.

When the tactile sensation presenting device 100 is used, the five tactile sensation presenting elements 1 are provided so as to be in contact with the fingertips of five fingers F of a user's hand H (drawn by broken lines in FIG. 1). Each of the tactile sensation presenting elements 1 presents tactile sensations by vibrational stimulation to the fingertip inner portion of a single finger F. Herein, the “fingertip inner portion” refers to a part fp of the finger F which is located beyond the first joint (distal joint) j1 of the finger F and which is located on the palm side relative to the center when the finger F is viewed from the side as shown in FIG. 2.

The control unit 2 controls the tactile sensation presenting elements 1. The control unit 2 controls the tactile sensation presenting elements 1 based on control signals transmitted from the PC 210. The data transmission between the control unit 2 and the PC 210 may be realized by wireless communication or wired communication. The wireless communication and wired communication can be established in compliance with various known communication standards. The control unit 2 is realized by, for example, a microcomputer.

The tactile sensation presenting elements 1 wired using flexible boards, wires, and the like, so as not to obstruct the movement of the hand H. The control unit 2 can be provided at, for example, a portion corresponding to a user's arm. The tactile sensation presenting elements 1 and the control unit 2 may be integrated in the form of a glove.

The PC 210 outputs video signals to the HMD 220, and the HMD 220 displays a video based on the received video signals. The HMD 220 also outputs position tracking data, which is information about the position of the HMD 220, and the like, to the PC 210. The data transmission between the PC 210 and the HMD 220 may be realized by wireless communication or wired communication.

Note that, in the example described herein, the tactile sensation presenting device 100 presents tactile sensations in conjunction with a video displayed by the HMD 220, although the use of the tactile sensation presenting device 100 is not limited to this example.

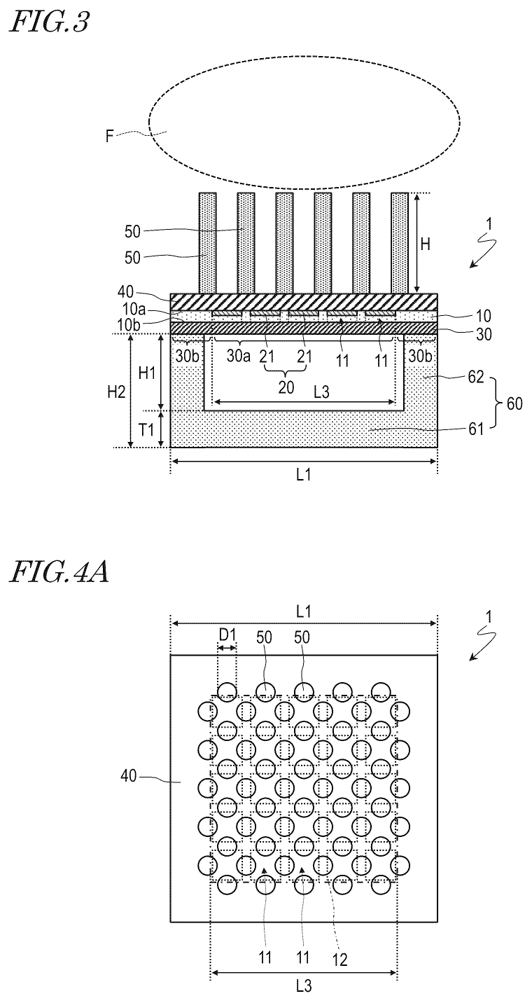

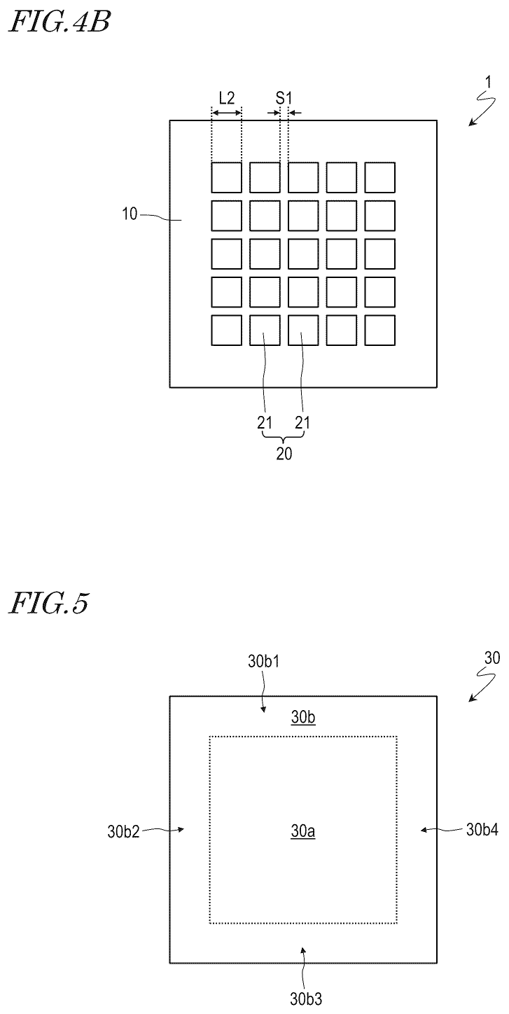

A specific configuration of the tactile sensation presenting element 1 is described with reference to FIG. 3, FIG. 4A and FIG. 4B. FIG. 3 is a cross-sectional view schematically showing the tactile sensation presenting element 1. FIG. 4A and FIG. 4B are plan views schematically showing the tactile sensation presenting element 1 as viewed from the front side. In FIG. 4B, some of the components of the tactile sensation presenting element 1 (the first substrate 40 and the protrusions 50, which will be described later) are not shown.

As shown in FIG. 3, FIG. 4A and FIG. 4B, the tactile sensation presenting element 1 includes a vibrator layer 10, a first electrode layer 20, a second electrode layer 30 and a first substrate 40. The tactile sensation presenting element 1 further includes a plurality of protrusions 50 and a fixing member 60. In the illustrated example, the tactile sensation presenting element 1 has a generally rectangular shape as viewed in plan, although the planar shape of the tactile sensation presenting element 1 is not limited to generally rectangular shapes.

The vibrator layer 10 undergoes physical deformation according to the applied voltage or applied current to generate vibration. Herein, the vibrator layer 10 is a piezoelectric layer that is made of a piezoelectric material. The piezoelectric material can be selected from a variety of known piezoelectric materials. For example, piezoelectric ceramic materials, such as zinc zirconate titanate (PZT), barium titanate (BaTiO₃), and the like, can be preferably used. Alternatively, the piezoelectric material may be a material in which piezoelectric ceramic particles are dispersed in a resin material. Still alternatively, piezoelectric materials other than the piezoelectric ceramic materials (e.g., piezoelectric single crystal materials, such as crystals) may be used.

The thickness of the piezoelectric layer 10 is not particularly limited. When a piezoelectric ceramic material is used as the piezoelectric material, the thickness of the piezoelectric layer 10 is preferably, for example, 0.2 mm or more from the viewpoint of securing a sufficient torque, and is preferably, for example, 0.19 mm or less from the viewpoint of securing the amount of displacement or reducing the driving voltage. When a material in which piezoelectric ceramic particles are dispersed in a resin material are used as the piezoelectric material, the thickness of the piezoelectric layer 10 is preferably, for example, 0.50 mm or more from the viewpoint of securing a sufficient torque, and is preferably, for example, 0.25 mm or less from the viewpoint of securing the amount of displacement or reducing the driving voltage.

Note that the vibrator layer is not limited to the exemplified vibrator layer. An organic actuator with the use of PVDF (polyvinylidene fluoride) or ion conductive polymers or a layer including a small induction coil, which will be described later, may be used as the vibrator layer. Since PVDF is one type of piezoelectric material, an organic actuator with the use of PVDF can be referred to as a piezoelectric layer.

The piezoelectric layer 10 has two major surfaces 10a and 10b located opposite to each other. Hereinafter, one of the major surfaces 10a and 10b which is located on the front side (finger F side), i.e., the major surface 10a, is referred to as “first major surface”, and the other major surface located on the rear side, i.e., the major surface 10b, is referred to as “second major surface”.

The first electrode layer 20 and the second electrode layer 30 are located opposite to each other with the piezoelectric layer 10 interposed therebetween. The first electrode layer 20 is located so as to be in contact with the first major surface 10a of the piezoelectric layer 10. The second electrode layer 30 is located so as to be in contact with the second major surface 10b of the piezoelectric layer 10.

The first electrode layer 20 consists of a plurality of separate electrodes 21 that are electrically independent of one another. In the illustrated example, the plurality of electrodes 21 are 25 electrodes 21 arrayed in 5 rows and 5 columns, and each of the electrodes 21 has a generally rectangular shape (more specifically, generally square shape) as viewed in plan. As a matter of course, the number and shape of electrodes 21 are not limited to those described herein. The first electrode layer 20 can be made of a variety of known electrically-conductive materials and, for example, can be suitably made of a metal such as copper (Cu), nickel (Ni), silver (Ag), gold (Au), an alloy such as Al—Nd alloy (aluminum neodymium alloy), or a metal oxide such as indium tin oxide (ITO). The thickness of the first electrode layer 20 including the plurality of electrodes 21 is not particularly limited but may be, for example, equal to or greater than 50 nm and equal to or smaller than 200 nm.

The second electrode layer 30 is formed by a single electrode (hereinafter, also referred to as “common electrode”) rather than a plurality of separate electrodes. In the illustrated example, the second electrode layer (common electrode) 30 has a generally rectangular shape as viewed in plan. The second electrode layer 30 can be made of a variety of known electrically-conductive materials and, for example, can be suitably made of a metal such as brass, copper (Cu), aluminum (Al). The thickness of the second electrode layer 30 is not particularly limited but may be, for example, equal to or greater than 0.01 mm and equal to or smaller than 0.2 mm.

When a voltage is applied between the second electrode layer (common electrode) 30 and each of the electrodes 21 of the first electrode layer 20, the piezoelectric layer 10 undergoes deformation. More specifically, a region of the piezoelectric layer 10 to which the voltage is applied expands or shrinks in the thickness direction. The potentials of the common electrode 30 and each of the electrodes 21 of the first electrode layer 20 are controlled by the control unit 2 (more specifically, by signals output from the control unit 2).

In the example shown herein, the deformation of the piezoelectric layer 10 occurs in each of regions 11 of the piezoelectric layer 10 corresponding to the electrodes 21 of the first electrode layer 20 (see FIG. 3 and FIG. 4A). That is, the piezoelectric layer (vibrator layer) 10 includes a plurality of regions 11, in each of which occurrence of vibration can be independently controlled. Hereinafter, each of these regions 11 of the piezoelectric layer 10 is referred to as “unit region”. Since each of the unit regions 11 of the piezoelectric layer 10 is defined by each of the electrodes 21 of the first electrode layer 20, each of the electrodes 21, which defines each of the unit regions 11 (i.e., corresponds to each of the unit regions 11), is hereinafter referred to as “unit electrode”. The shape of the unit regions 11 as viewed in plan is equal to the shape of the unit electrodes 21 (in the illustrated example, generally rectangular shape). Hereinafter, a region 12 of the piezoelectric layer (vibrator layer) 10 including the plurality of unit regions 11 is referred to as “vibration region”. The outline of the vibration region 12 is shown as chain lines in FIG. 4A. In the illustrated example, the vibration region 12 has a generally rectangular shape as viewed in plan.

The first substrate 40 is located opposite to the piezoelectric layer 10 relative to the first electrode layer 20 (i.e., on the front side of the first electrode layer 20) and supports the first electrode layer 20. The first substrate 40 is insulative. The first substrate 40 has such flexibility that it can deform according to the deformation of the piezoelectric layer 10.

The first substrate 40 can be a resin substrate (plastic substrate) that is made of a resin material (e.g., polyimide). The first substrate 40 may be a film. The thickness of the first substrate 40 is, for example, equal to or greater than 10 μm and equal to or smaller than 100 μm.

The plurality of protrusions 50 protrude from the first substrate 40 to the side opposite to the first electrode layer 20 side. That is, the plurality of protrusions 50 are located opposite to the piezoelectric layer 10 relative to the first electrode layer 20. It can also be said that the first substrate 40 is located between the first electrode layer 20 and the plurality of protrusions 50. In the illustrated example, each of the plurality of protrusions 50 has the shape of a circular cylinder. Specifically, the shape of the transverse cross section of each protrusion is substantially constant along the height direction of each protrusion 50 and is generally circular. In the illustrated example, as shown in FIG. 4A, the plurality of protrusions 50 do not overlap the centers of corresponding ones of the plurality of unit regions 11 as viewed in plan. Each of the protrusions 50 is located so as to extend across the outer boundary of one or two unit regions 11 as viewed in plan, and a single protrusion 50 extends across each side of each unit region 11. The protrusions 50 are preferably made of a resin material such as polyethylene but may be made of a metal material such as copper (Cu).

The fixing member 60 is located opposite to the piezoelectric layer 10 relative to the second electrode layer (common electrode) 30. The fixing member 60 is joined with the peripheral portion of the common electrode 30 so as to fix the peripheral portion of the common electrode 30. Herein, as shown in FIG. 5, where a region 30a of the common electrode 30 overlapping the vibration region 12 of the piezoelectric layer 10 as viewed in plan is referred to as “first region” and a region 30b of the common electrode 30 located outside the first region 30a (in the illustrated example, surrounding the first region 30a) as viewed in plan is referred to as “second region”, it can also be said that the fixing member 60 is joined with the second region 30b of the common electrode 30 so as to fix the second region 30b of the common electrode 30. In the illustrated example, the first region 30a has a generally rectangular shape. The second region 30b has a generally quadrangular frame-like shape and includes four side portions 30b1, 30b2, 30b3 and 30b4.

In the illustrated example, the fixing member 60 has a box-like shape without the top surface. The fixing member 60 includes a bottom 61 and a lateral wall 62 protruding from the peripheral portion of the bottom 61 toward the second electrode layer 30 side. The lateral wall 62 of the fixing member 60 is joined with the second region 30b of the common electrode 30. Note that the fixing member 60 does not necessarily need to fix all of the four side portions 30b1, 30b2, 30b3 and 30b4 of the second region 30b but may fix only some of them. For example, the fixing member 60 may fix only a pair of side portions which are opposite to each other (only the side portions 30b1 and 30b3 or only the side portions 30b2 and 30b4). Alternatively, the fixing member 60 may be omitted.

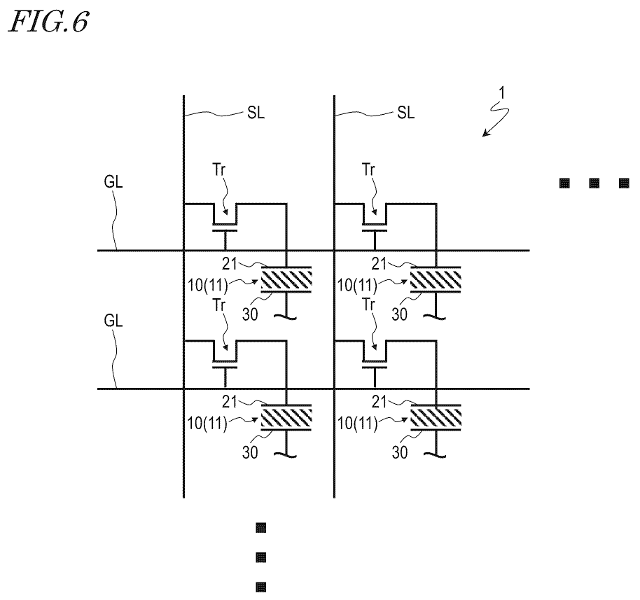

Although not shown in FIG. 3, FIG. 4A and FIG. 4B, on one of the major surfaces of the first substrate 40 located on the piezoelectric layer 10 side, wires for driving the plurality of unit electrodes 21 (i.e., for applying signals (voltage) to each of the unit electrodes 21) are provided. FIG. 6 shows an example of the equivalent circuit of the tactile sensation presenting element 1. In the example shown in FIG. 6, the tactile sensation presenting element 1 includes a plurality of gate lines GL, a plurality of source lines SL, and a plurality of transistors Tr.

Each of the plurality of transistors Tr is provided for a corresponding one of the unit electrodes 21. The gate electrodes of the transistors Tr are electrically coupled with corresponding gate lines GL. The source electrodes of the transistors Tr are electrically coupled with corresponding source lines SL. The drain electrodes of the transistors Tr are electrically coupled with corresponding unit electrodes 21. Since predetermined signals (voltage) are applied to each of the unit electrodes 21 via the transistor Tr, deformation (expansion and shrinkage) of the piezoelectric layer 10 can be caused, and vibration can be caused, independently in a region corresponding to each of the unit electrodes 21 (unit region 11). Preferably, the frequency of the vibration is, for example, equal to or higher than 10 Hz and equal to or lower than 300 Hz. Note that, however, vibrational stimulation may be realized by amplitude modulation (AM) of the vibration in the ultrasonic range (20 kHz or higher).

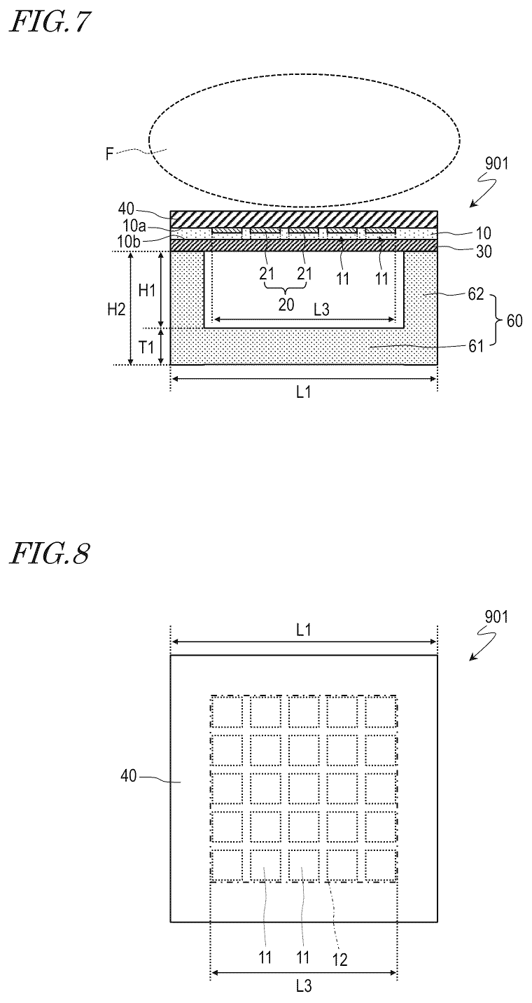

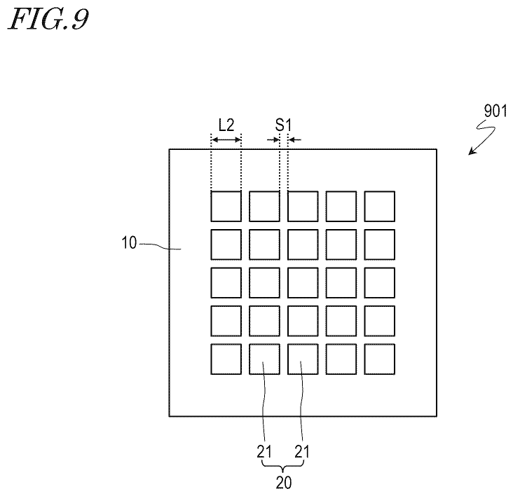

As described above, in the tactile sensation presenting element 1 of the present embodiment, the first electrode layer 20 consists of the plurality of separate electrodes 21 that are electrically independent of one another and, therefore, there are a plurality of vibration channels, so that the resolution of tactile sensations to be presented can be increased. The tactile sensation presenting element 1 of the present embodiment includes the plurality of protrusions 50 and can hence reduce such problems that a user senses a vibration at a position away from a portion at which the vibration is actually generated and that a user senses a vibration in a broader area than the portion at which the vibration is actually generated. Hereinafter, this point is described in comparison to the tactile sensation presenting element 901 of Comparative Example shown in FIG. 7, FIG. 8 and FIG. 9.

FIG. 7 is a cross-sectional view schematically showing the tactile sensation presenting element 901 of Comparative Example. FIG. 8 and FIG. 9 are plan views schematically showing the tactile sensation presenting element 901 as viewed from the front side. In FIG. 9, part of the components of the tactile sensation presenting element 901 (the first substrate 40) is not shown.

As shown in FIG. 7, FIG. 8 and FIG. 9, the tactile sensation presenting element 901 of Comparative Example includes a piezoelectric layer 10, a first electrode layer 20, a second electrode layer 30, a first substrate 40 and a fixing member 60 as does the tactile sensation presenting element 1 of the present embodiment. Note that, however, the tactile sensation presenting element 901 of Comparative Example is different from the tactile sensation presenting element 1 of the present embodiment in that the tactile sensation presenting element 901 does not include the plurality of protrusions 50. The tactile sensation presenting element 901 of Comparative Example was test-produced according to the specifications shown in TABLE 1, and verification of presented tactile sensations was conducted.

TABLE 1

| L1: Length of each side of | | 7.0 | mm |
|---|---|---|---|
| tactile sensation presenting element | | | |
| Piezoelectric layer | Material | PZT | |
| | Thickness | 0.19 | mm |
| First | Material | Copper | |
| electrode layer | Thickness | 100 | nm |
| Unit electrode | L2: Length of each side | 0.8 | mm |
| | S1: Gap | 0.2 | mm |
| L3: Length of each side of vibration region | | 4.8 | mm |
| Second | Material | Brass | |
| electrode layer | Thickness | 0.13 | mm |
| First substrate | Material | Polyimide | |
| | Thickness | 50 | μm |
| Fixing member | Material | Acrylic resin | |
| | T1: Thickness of | 1.0 | mm |
| | bottom | | |
| | H1: Height of | 2.0 | mm |
| | lateral wall | | |
| | H2: Total height | 3.0 | mm |

As shown in TABLE 1, the length of each side of the tactile sensation presenting element 901 as viewed in plan, L1, was 7.0 mm. Likewise, the length of each side of the piezoelectric layer 10, the second electrode layer 30, the first substrate 40 and the fixing member 60 as viewed in plan was also 7.0 mm. The piezoelectric layer 10 was made of PZT, and the thickness of the piezoelectric layer 10 was 0.19 mm. The first electrode layer 20 including 25 unit electrodes 21 arrayed in 5 rows and 5 columns was made of copper (Cu), and the thickness of the first electrode layer 20 was 100 nm. Each of the unit electrodes 21 had the shape of a square whose length on each side, L2, was 0.8 mm, and the gap between neighboring unit electrodes 21, S1, was 0.2 mm. The vibration region 12 of the piezoelectric layer 10 as viewed in plan had the shape of a square whose length on each side, L3, was 4.8 mm. The second electrode layer (common electrode) 30 was made of brass, and the thickness of the second electrode layer (common electrode) 30 was 0.13 mm.

The first substrate 40 was made of polyimide, and the thickness of the first substrate 40 was 50 μm. The first substrate 40 with the first electrode layer 20 formed thereon was adhered to the piezoelectric layer 10 with an adhesive agent. The fixing member 60 was made of an acrylic resin. The thickness of the bottom 61 of the fixing member 60, T1, was 1.0 mm and the height of the lateral wall 62, H1, was 2.0 mm (i.e., the total height of the fixing member 60, H2, was 3.0 mm). The fixing member 60 was joined with the peripheral portion of the second electrode layer 30.

Predetermined signals were output to each of the unit electrodes 21 and the common electrode 30 of the test-produced tactile sensation presenting element 901 such that a vibration was generated. The refresh rate was 200 Hz, and the gate open time of a region corresponding to each of the unit electrodes 21 was 0.2 ms.

We evaluated presented tactile sensations with a finger F being in contact with the surface of the first substrate 40 of the test-produced tactile sensation presenting element 901, and found that varying the output signals gave a sensation as if the materials were different. However, the sensations were felt as if a portion at which the vibration occurred (vibration source) had been present deeper than the surface by about 1 cm rather than at the surface of the finger F. This is probably because the vibration laterally propagated in the tactile sensation presenting element 901 and a plurality of sensory receptors sensed the vibration with generally equal intensities, so that the brain empirically made such process and determination (i.e., the tactile sensations were felt as if the vibration source had been present deeper than the surface of the finger F).

The tactile sensation presenting element 1 of the present embodiment was also test-produced, and verification of presented tactile sensations was conducted. The materials and dimensions (e.g., thickness) of the piezoelectric layer 10, the first electrode layer 20, the second electrode layer 30, the first substrate 40 and the fixing member 60 were the same as those of the tactile sensation presenting element 901 of Comparative Example. The specifications of the protrusions 50 are as shown in TABLE 2. As shown in TABLE 2, the plurality of cylindrical protrusions 50 were made of polyethylene, the height of each protrusion 50, H, was 3.0 mm, and the diameter of each protrusion 50, D1, was 0.5 mm.

TABLE 2

| | | |
|---|---|---|
| Protrusions | Shape | Cylindrical |
| | Material | Polyethylene |
| | Height H | 3.0 mm |
| | Diameter D1 | 0.5 mm |

Predetermined signals were output to each of the unit electrodes 21 and the common electrode 30 of the test-produced tactile sensation presenting element 1 such that a vibration was generated. The refresh rate was 200 Hz, and the gate open time of a region corresponding to each of the unit electrodes 21 was 0.2 ms.

We evaluated presented tactile sensations with a finger F being in contact with the apex surfaces of the protrusions 50 of the test-produced tactile sensation presenting element 1, and found that varying the output signals gave a sensation as if the materials were different. Further, the sensations were felt such that the vibration source was present at the surface of the finger F. Further, as compared with the tactile sensation presenting element 901 of Comparative Example to which the same signals were output, the tactile sensations were felt dry, and the resolution of the tactile sensations was high. That is, the vibrations were felt in a narrow range as compared with the tactile sensation presenting element 901 of Comparative Example.

Thus, the tactile sensation presenting element 1 of the present embodiment can accurately present tactile sensations in minute regions. The mechanism of achieving such effects is inferred as follows.

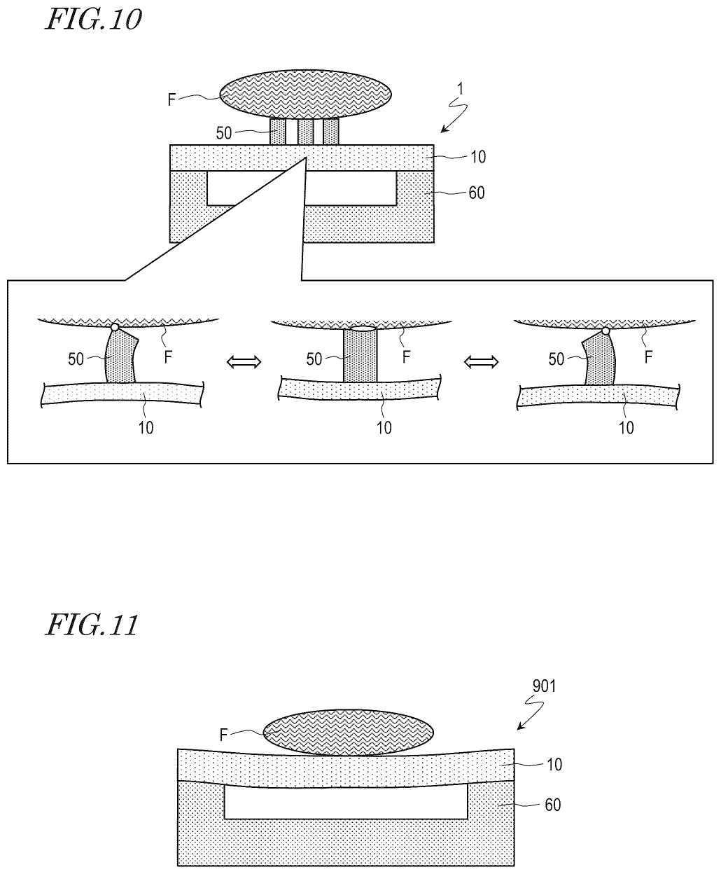

FIG. 10 illustrates the aforementioned mechanism. Note that, in FIG. 10, the first electrode layer 20, the second electrode layer 30 and the first substrate 40 are not shown.

As illustrated in FIG. 10, when vibrations occur, the protrusions 50 deforms so that the area of contact with the finger F varies spatially and temporally in a minute region. Accordingly, it is estimated that, the difference in intensity of sensed vibrations between neighboring sensory receptors is not negligible, and the brain performs a process to recognize that the vibration source is present at the surface of the finger F. For example, as for the vision also, it is known that when the difference between the distances from a target object to the right and left eyes is small, the brain performs a process to recognize that the object is distant, but when the difference is large, the brain performs a process to recognize that the object is close, and it is inferred that this is a similar mechanism.

Further, the tactile sensation presenting element 1 of the present embodiment can achieve the following effects.

In the tactile sensation presenting element 901 of Comparative Example that does not include the protrusions 50, as illustrated in FIG. 11 (similarly to FIG. 10, the first electrode layer 20, the second electrode layer 30 and the first substrate 40 are not shown), if the tactile sensation presenting element 901 is strongly depressed with the finger F, there is a probability that no vibration will occur due to insufficient torque.

In comparison, the tactile sensation presenting element 1 of the present embodiment includes the protrusions 50 located between the piezoelectric layer 10 and the finger F. Therefore, even if the tactile sensation presenting element 1 is strongly depressed with the finger F, the protrusions 50 laterally deforms as illustrated in FIG. 10, so that sufficient vibrations can occur.

Since the tactile sensation presenting element 1 of the present embodiment is typically not to be stroked with the finger F, the relative positions of the tactile sensation presenting element 1 and the finger F are fixed when viewed macroscopically (although microscopic variation of the relative positions can occur due to microvibration of the protrusions 50 caused by driving of the tactile sensation presenting element 1). Thus, the area of the vibration region 12 in a single tactile sensation presenting element 1 (i.e., the area of the vibration region 12 corresponding to the fingertip inner portion fp of a single finger F) is, for example, equal to or smaller than 9 cm².

### [Height and Young's Modulus of Protrusions]

From the viewpoint of suitably causing lateral deformation of the protrusions 50, it is preferred that the height H of the protrusions 50 is somewhat large. When each of the unit regions 11 has a generally rectangular shape as viewed in plan, the height H of each protrusion 50 is preferably equal to or greater than twice, more preferably equal to or greater than three times, the shortest one of the sides of each unit region 11 (the short side of an oblong rectangle or each side of a square) as viewed in plan.

From the viewpoint of suitably causing lateral deformation of the protrusions 50, it is preferred that the protrusions 50 are slender, i.e., the aspect ratio of the protrusions 50 (the ratio of the height to the width) is high. As previously illustrated, the shape of the transverse cross section of each protrusion 50 is substantially constant along the height direction of each protrusion 50, and this case can be formulated as follows. That is, it is preferred that the transverse cross-sectional area A and the height H of each protrusion 50 satisfy the relationship of H≥(2·A^{0.5})/H.

The shape of the transverse cross section of each protrusion 50 is not limited to the illustrated generally circular shape but may be, for example, a generally elliptical shape, a generally rectangular shape, a generally equilateral triangular shape, or a generally equilateral convex polygonal shape, or may be any other shape. The protrusions 50 may be partially joined together so long as their shape remains at such a level that they can be called protrusions or so long as lateral vibrations are not restrained. For example, in order to block entry of foreign objects into the gap between the protrusions 50, the apex surfaces of the plurality of protrusions 50 may be joined with a very thin film (e.g., a 10 μm thick film of polyvinylidene chloride (PVDC), polyvinyl chloride resin (PVC), polymethylpentene (PMP), or polyethylene (PE)).

From the viewpoint of suitably causing lateral deformation of the protrusions 50, it is preferred that the Young's modulus of each protrusion 50 is somewhat small, specifically equal to or smaller than 20 GPa.

### [Number of Unit Electrodes]

In the above-described configuration example, the first electrode layer 20 includes 25 unit electrodes 21, although the number of unit electrodes 21 may be two or more and is not limited to 25. When the second electrode layer 30 is a common electrode (i.e., when the second electrode layer 30 does not consist of a plurality of separate unit electrodes), it is preferred from the viewpoint of increasing the resolution of tactile sensations that the plurality of unit electrodes 21 of the first electrode layer 20 are nine or more unit electrodes 21 arrayed in m rows and n columns (m and n are each an integer equal to or greater than three), i.e., the first electrode layer 20 consists of nine or more separate unit electrodes 21.

### [Configuration Including Second Substrate]

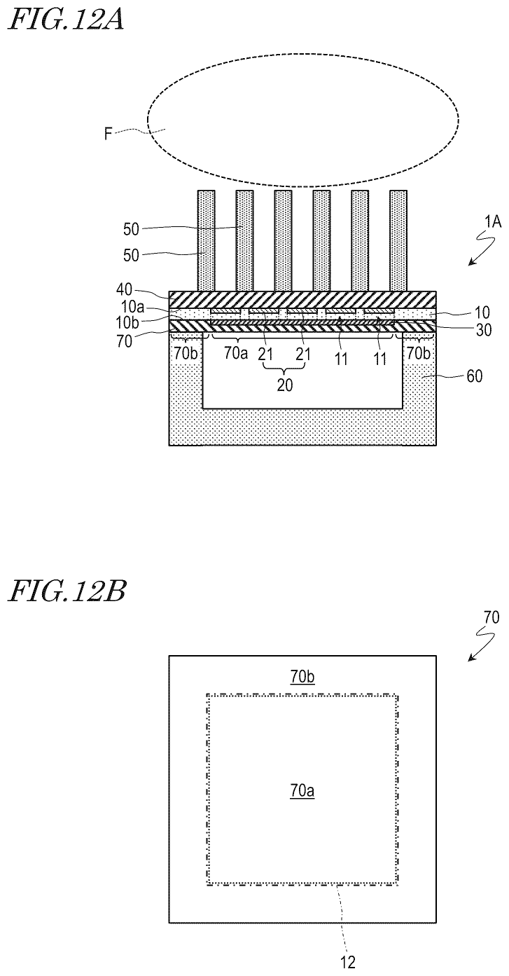

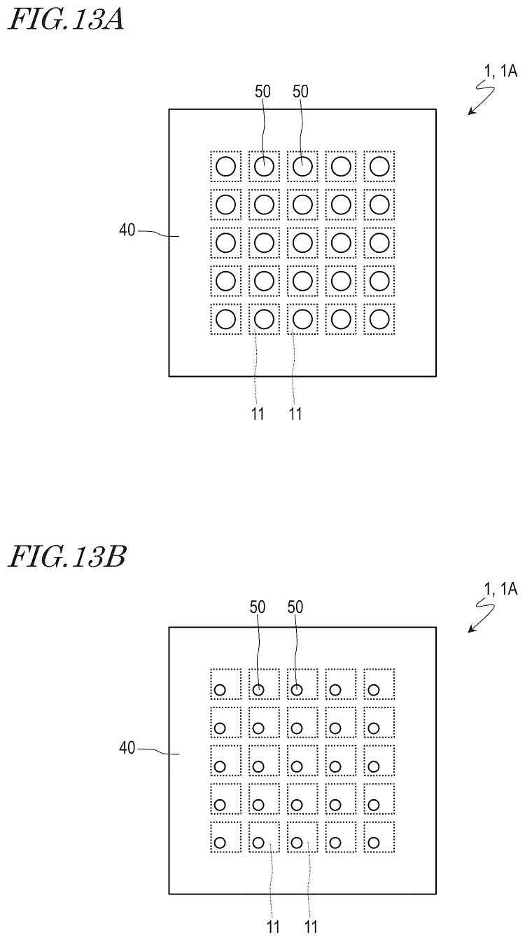

Another tactile sensation presenting element 1A according to an embodiment of the present invention is described with reference to FIG. 12A. FIG. 12A is a cross-sectional view schematically showing the tactile sensation presenting element 1A.

In the tactile sensation presenting element 1 shown in FIG. 3, FIG. 4A and FIG. 4B, the second electrode layer 30 is not directly supported by the substrate and is different from the first electrode layer 20 in this point. That is, it can be said that the second electrode layer 30 is relatively thick such that it is self-supportable.

The tactile sensation presenting element 1A shown in FIG. 12A is different from the tactile sensation presenting element 1 in that the tactile sensation presenting element 1A includes a second substrate 70 that is located opposite to the piezoelectric layer 10 relative to the second electrode layer 30 and that supports the second electrode layer 30.

In the tactile sensation presenting element 1A, the second electrode layer 30 may be relatively thin such that it is not self-supportable. The second electrode layer 30 can suitably be made of a metal such as copper (Cu), nickel (Ni), silver (Ag), gold (Au), an alloy such as Al—Nd alloy (aluminum neodymium alloy), or a metal oxide such as indium tin oxide (ITO). The thickness of the second electrode layer 30 is, for example, equal to or greater than 50 nm and equal to or smaller than 200 nm.

The second substrate 70 is insulative. The second substrate 70 has such flexibility that it can deform according to deformation of the piezoelectric layer 10. The second substrate 70 can be a resin substrate (plastic substrate) that is made of a resin material (e.g., PET or polyimide). The second substrate 70 may be a film. The thickness of the second substrate 70 is, for example, equal to or greater than 10 μm and equal to or smaller than 100 μm.

The fixing member 60 is joined with the peripheral portion of the second substrate 70 so as to fix the peripheral portion of the second substrate 70. Herein, as shown in FIG. 12B, where a region 70a of the second substrate 70 overlapping the vibration region 12 of the piezoelectric layer 10 as viewed in plan is referred to as “first region” and a region 70b of the second substrate 70 located outside the first region 70a (in the illustrated example, surrounding the first region 70a) as viewed in plan is referred to as “second region”, it can also be said that the fixing member 60 is joined with the second region 70b of the second substrate 70 so as to fix the second region 70b of the second substrate 70.

As for the tactile sensation presenting element 1A shown in FIG. 12A and the tactile sensation presenting element 1 shown in FIG. 3, FIG. 4A and FIG. 4B, the behavior in presentation of tactile sensations was verified by vibration simulations. In the simulations, the pre-processing software used was HyperMesh manufactured by Altair, and the solver was OptiStruct manufactured by Altair. In the simulations, the piezoelectric layer 10, the first electrode layer 20, the first substrate 40, the protrusions 50 and the fixing member 60 were prepared according to the specifications shown in TABLE 1 and TABLE 2. The second electrode layer 30 of the tactile sensation presenting element 1 was prepared according to the specifications shown in TABLE 1. The second substrate 70 of the tactile sensation presenting element 1A was made of a resin material, and the thickness of the second substrate 70 was 0.05 mm. The second electrode layer 30 of the tactile sensation presenting element 1A was very thin (thickness: 100 nm) and hence considered negligible.

By simulations, the vibration strength in the tactile sensation presenting element 1A and the tactile sensation presenting element 1 was evaluated. The vibration strength was represented by the magnitude M [mm] as shown in the following formula.

M=Δx²+Δy²+Δz²

Herein, Δx, Δy, Δz are the displacements in the x-, y-, and z-axis directions, respectively. The x-, y-, and z-axes are three mutually orthogonal axes. The z-axis is parallel to the normal direction of the major surfaces 1a, 1b of the piezoelectric layer 10 (the height direction of the protrusions 50).

As a result of the above-described verification by simulations, it was confirmed that, in the tactile sensation presenting element 1A, the magnitude was relatively high immediately above the vibration source (a portion in which the piezoelectric layer 10 was deformed) as compared with the tactile sensation presenting element 1. Thus, it can be said that, in the tactile sensation presenting element 1A, the resolution of tactile sensations is high as compared with the tactile sensation presenting element 1.

### [Arrangement of Protrusions, Thickness of Second Substrate, Etc.]

In the example shown in FIG. 4A, each protrusion 50 does not overlap the centers of the unit regions 11 but located so as to extend across the outer boundary of the unit regions 11 as viewed in plan, although the arrangement of the protrusions 50 is not limited to this example.

FIG. 13A shows another example of the arrangement of the protrusions 50. In the example shown in FIG. 13A, each protrusion 50 overlaps the center of the unit region 11 as viewed in plan. Each protrusion 50 does not extend across the outer boundary of the unit regions 11 as viewed in plan.

FIG. 13B shows still another example of the arrangement of the protrusions 50. In the example shown in FIG. 13B, each protrusion 50 does not overlap the centers of the unit regions 11 as viewed in plan. Each protrusion 50 does not extend across the outer boundary of the unit regions 11 as viewed in plan.

The arrangements shown in FIG. 13A and FIG. 13B may be employed instead of the arrangement shown in FIG. 4A. Note that, however, according to the study by the inventors of the present application, it was found that the arrangements shown in FIG. 4A and FIG. 13B where the protrusions 50 do not overlap the centers of the unit electrodes 21 are preferable to the arrangement shown in FIG. 13A where the protrusions 50 overlap the centers of the unit electrodes 21. This point is described in the following.

Vibration simulations were carried out on configuration including the second substrate 70, such as the tactile sensation presenting element 1A shown in FIG. 12A, with the arrangement of the protrusions 50 shown in FIG. 4A (hereinafter, referred to as “protrusion arrangement A”) and the arrangement of the protrusions 50 shown in FIG. 13A (hereinafter, referred to as “protrusion arrangement B”). In the simulations, the pre-processing software used was HyperMesh manufactured by Altair, and the solver was OptiStruct manufactured by Altair, similarly to the previously-described verification. The piezoelectric layer 10, the first electrode layer 20, the first substrate 40, the protrusions 50 and the fixing member 60 were prepared according to the specifications shown in TABLE 1 and TABLE 2 (except that the material of the fixing member 60 was iron), and the second electrode layer 30 was very thin (thickness: 100 nm) and hence considered negligible. The Young's modulus, Poisson's ratio and density of the protrusions 50, the first substrate 40, the piezoelectric layer 10, the second substrate 70 and the fixing member 60 were as shown in TABLE 3.

TABLE 3

| | Young's | | |
|---|---|---|---|
| | modulus | Poisson's | Density |
| | (GPa) | ratio | (g/cm³) |
| Protrusions | 1 | 0.35 | 0.95 |
| First substrate | 2.5 | 0.35 | 1.3 |
| Piezoelectric | 58.48 | 0.3 | 7.9 |
| layer | | | |
| Second substrate | E | 0.3 | 8.73 |
| Fixing member | 210 | 0.3 | 7.9 |

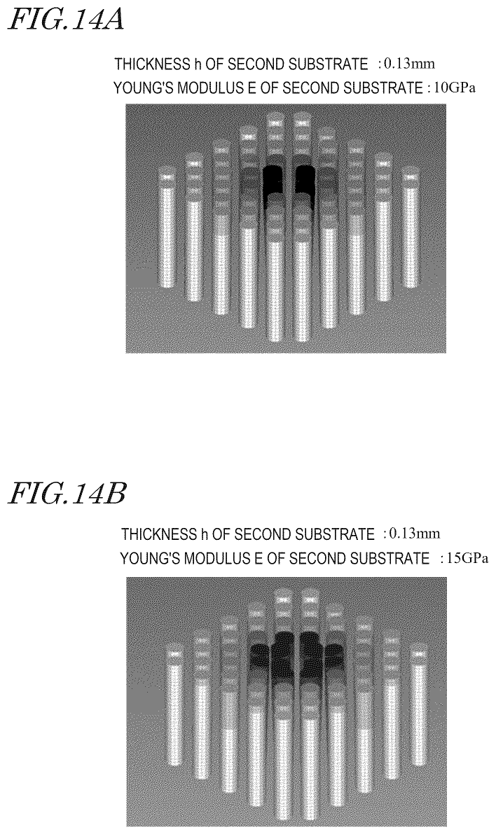

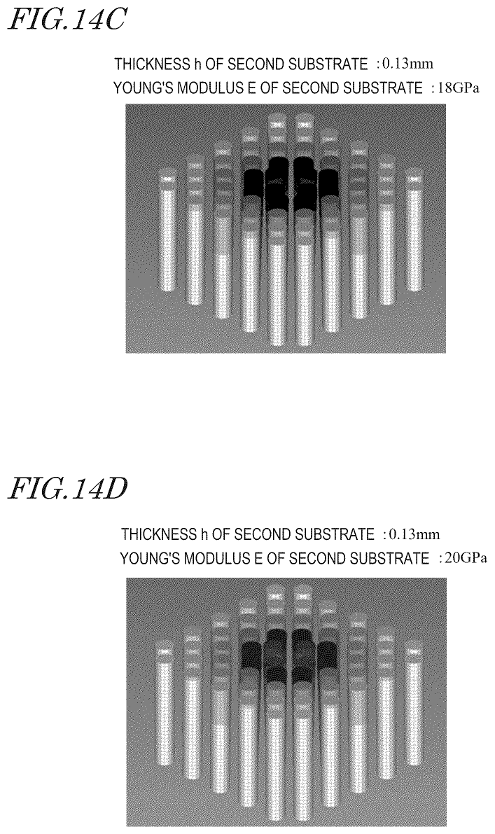

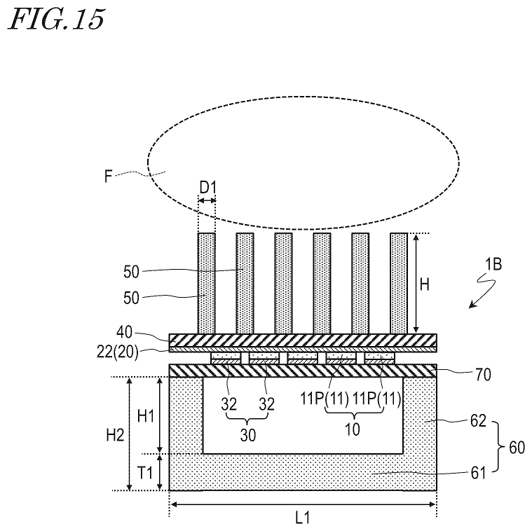

The results of the simulations carried out with varying thickness h [mm] and varying Young's modulus E [GPa] of the second substrate 70 are shown in TABLE 4, TABLE 5 and TABLE 6. The result windows of simulations under some conditions are shown in FIG. 14A, FIG. 14B, FIG. 14C and FIG. 14D.

TABLE 4

| Second substrate | | | Protrusion arrangement A | | Protrusion arrangement B | | |
|---|---|---|---|---|---|---|---|
| | Young's | | | Maximum | | Maximum | No |
| Thickness | modulus | | | amplitude | | amplitude | protrusions |
| h (mm) | E (GPa ) | E · h | Magnitude | position | Magnitude | position | Magnitude |
| 0.01 | 10 | 0.10 | — | — | 1.082 × 10⁻⁵ | Center | — |
| 0.01 | 13 | 0.13 | — | — | 9.979 × 10⁻⁶ | Center | — |
| 0.01 | 26 | 0.26 | — | — | 1.174 × 10⁻⁵ | Periphery | — |
| 0.01 | 50 | 0.50 | — | — | 2.138 × 10⁻⁵ | Periphery | — |
| 0.01 | 130 | 1.30 | 6.188 × 10⁻⁵ | Center | — | — | — |
| 0.01 | 260 | 2.60 | 5.917 × 10⁻⁵ | Periphery | — | — | — |
| 0.065 | 1 | 0.07 | — | — | 1.211 × 10⁻⁵ | Center | — |
| 0.065 | 2 | 0.13 | 1.161 × 10⁻⁴ | Center | 9.779 × 10⁻⁶ | Center | — |
| 0.065 | 4 | 0.26 | — | — | 1.450 × 10⁻⁵ | Periphery | — |
| 0.065 | 10 | 0.65 | — | — | 3.154 × 10⁻⁵ | Periphery | — |
| 0.065 | 20 | 1.30 | 6.308 × 10⁻⁵ | Center | — | — | — |
| 0.065 | 40 | 2.60 | 6.113 × 10⁻⁵ | Periphery | — | — | — |

TABLE 5

| Second substrate | | | Protrusion arrangement A | | Protrusion arrangement B | | |
|---|---|---|---|---|---|---|---|
| | Young's | | | Maximum | | Maximum | No |
| Thickness | modulus | | | amplitude | | amplitude | protrusions |
| h (mm) | E (GPa ) | E · h | Magnitude | position | Magnitude | position | Magnitude |
| 0.13 | 0.02 | 0.00 | 1.280 × 10⁻⁴ | Center | 1.654 × 10⁻⁵ | Center | 2.176 × 10⁻⁵ |
| 0.13 | 0.2 | 0.03 | 1.248 × 10⁻⁴ | Center | 1.367 × 10⁻⁵ | Center | — |
| 0.13 | 1 | 0.13 | 1.155 × 10⁻⁴ | Center | 9.514 × 10⁻⁶ | Center | — |
| 0.13 | 2 | 0.26 | 1.062 × 10⁻⁴ | Center | 1.801 × 10⁻⁵ | Periphery | — |
| 0.13 | 10 | 1.30 | 6.951 × 10⁻⁵ | Center | 5.291 × 10⁻⁵ | Periphery | — |
| 0.13 | 15 | 1.95 | 5.962 × 10⁻⁵ | Center | — | — | — |
| 0.13 | 18 | 2.34 | 5.804 × 10⁻⁵ | Periphery | — | — | — |
| 0.13 | 20 | 2.60 | 5.999 × 10⁻⁵ | Periphery | 6.927 × 10⁻⁵ | Periphery | — |
| 0.13 | 110 | 14.30 | 7.711 × 10⁻⁵ | Periphery | 8.937 × 10⁻⁵ | Periphery | 5.360 × 10⁻⁵ |
| 0.13 | 200 | 26.00 | 9.975 × 10⁻⁵ | Periphery | 8.883 × 10⁻⁵ | Periphery | — |
| 0.13 | 20000 | 2600.00 | — | — | 1.132 × 10⁻⁵ | Center | — |

TABLE 6

| Second substrate | | | Protrusion arrangement A | | Protrusion arrangement B | | |
|---|---|---|---|---|---|---|---|
| | Young's | | | Maximum | | Maximum | No |
| Thickness | modulus | | | amplitude | | amplitude | protrusions |
| h (mm) | E (GPa ) | E · h | Magnitude | position | Magnitude | position | Magnitude |
| 0.2 | 6.5 | 1.30 | 7.762 × 10⁻⁵ | Center | — | — | — |
| 0.2 | 13 | 2.60 | 6.641 × 10⁻⁵ | Center | — | — | — |
| 0.2 | 20 | 4.00 | 6.191 × 10⁻⁵ | Center · | — | — | — |
| | | | | Periphery | | | |
| 0.2 | 30 | 6.00 | 6.349 × 10⁻⁵ | Periphery | — | — | — |
| 0.26 | 5 | 1.30 | 8.398 × 10⁻⁵ | Center | — | — | — |
| 0.26 | 10 | 2.60 | 7.567 × 10⁻⁵ | Center | — | — | — |

TABLE 4, TABLE 5 and TABLE 6 show the magnitude and the maximum amplitude position. In the simulations, the vibration source was at the center of the piezoelectric layer 10 as viewed in plan. In the tables, “Center” refers to a case where the maximum amplitude position is the protrusion(s) 50 located immediately above the vibration source (e.g., in the example shown in FIG. 4A, four protrusions 50 located near the center), and “Periphery” refers to a case where the maximum amplitude position is the protrusion(s) 50 located at a position away from the area immediately above the vibration source. It is preferred that the magnitude is as large as possible, and it is preferred that the maximum amplitude position occurs at the center. In FIG. 14A, FIG. 14B, FIG. 14C and FIG. 14D, the magnitude is shown in shades of gray. As the color is closer to black, it means that the magnitude is greater, and as the color is closer to white, it means that the magnitude is smaller. FIG. 14A and FIG. 14B show examples where the maximum amplitude position occurs at the center. FIG. 14C and FIG. 14D show examples where the maximum amplitude position occurs at the periphery (i.e., away from the center).

TABLE 4, TABLE 5 and TABLE 6 show not only the thickness h and Young's modulus E of the second substrate 70 but also the product of these parameters, E·h. It is considered that this parameter E·h can be used as an index of stiffness for the following reasons.

The relationship between the load F and the displacement d is expressed as F=k·d in the linear range. Herein, k is the spring constant and represents the stiffness, including both the stiffness attributed to the material and the stiffness attributed to the shape.

Meanwhile, the stress σ is expressed as σ=ε·E using strain ε and Young's modulus E. From this formula, the formula of F/S=(ΔL/L)·E is obtained using the load F, the cross-sectional area S and the length L, and the definition of the stress σ and the definition of the strain E. Further, if the displacement d is equivalent to ΔL (d=ΔL), the formula of k=(E·S)/L is obtained. It can be said that, in this formula, E represents the stiffness attributed to the material and S/L represents the stiffness attributed to the shape. Also, in this formula, if the cross-sectional area S is equivalent to the product of the length L and the thickness h (i.e., S=L·h), k=E·h holds, and therefore, it can be considered that the parameter E·h represents a type of stiffness.

As seen from TABLE 4, TABLE 5 and TABLE 6, the following trend was found: if the parameter E·h was relatively small (i.e., the stiffness was relatively low), the maximum amplitude position occurred at the center; if the parameter E·h was relatively large (i.e., the stiffness was relatively high), the maximum amplitude position occurred at the periphery; if the parameter E·h was extremely large (i.e., the stiffness was extremely high), the maximum amplitude position occurred at the center. In out estimation, this is because the vibration laterally propagates to more distant positions as the stiffness increases, but if the stiffness is extremely high, conversely, the vibration is unlikely to propagate.

In protrusion arrangement B, when the thickness of the second substrate 70 is 0.13 mm, as seen from TABLE 5, the maximum amplitude position cannot occur at the center without meeting such a condition that the Young's modulus E of the second substrate 70 is equal to or smaller than 1 GPa or is about 20000 GPa (100 times that of iron). Considering that the Young's modulus of the resin is about 2 GPa, it is not very realistic to set the Young's modulus E of the second substrate 70 to such a value. In protrusion arrangement B, when the thickness of the second substrate 70 is a half of 0.13 mm, i.e., 0.065 mm, the changing point of the maximum amplitude position is within the range of 2 GPa to 4 GPa, and therefore, the maximum amplitude position can occur at the center even if the second substrate 70 is made of a material whose Young's modulus is at the same level as that of the resin.

In protrusion arrangement A, when the thickness of the second substrate 70 is 0.13 mm, as seen from TABLE 5 (and comparison of FIG. 14A and FIG. 14B with FIG. 14C and FIG. 14D), the maximum amplitude position can occur at the center so long as the Young's modulus E of the second substrate 70 is equal to or smaller than 15 GPa. Also, in protrusion arrangement A, when the thickness of the second substrate 70 is 0.065 mm, as seen from TABLE 4, the maximum amplitude position can occur at the center so long as the Young's modulus E of the second substrate 70 is equal to or smaller than 20 GPa.

Thus, from the viewpoint of adopting wider ranges of material and thickness for the second substrate 70, protrusions arrangement A is preferable to protrusions arrangement B. Also, protrusion arrangement A is preferable because, when the parameter E·h is equal to or smaller than 1.95 GPa, i.e., the thickness h [mm] and Young's modulus E [GPa] of the second substrate 70 satisfy the relationship of E·h≤1.95, the maximum amplitude position can occur at the center.

Since the amplitude of vibrations is larger in protrusion arrangement B than in protrusion arrangement A, it seems preferable to adopt protrusion arrangement B. However, contrary to such common technical knowledge, we made a new finding that, as previously described, the arrangement in which the protrusions 50 do not overlap the centers of the unit regions 11 is preferable to the arrangement in which the protrusions 50 overlap the centers of the unit regions 11. When arranged so as not to overlap the centers of the unit regions 11, the plurality of protrusions 50 may include protrusions 50 located so as to extend across the outer boundary of the unit regions 11 as viewed in plan (referred to as “first protrusions”). As shown in FIG. 4A, when the unit regions 11 have a generally rectangular shape as viewed in plan, one or more first protrusions may extend across each side of the unit regions 11 as viewed in plan. Also, the plurality of protrusions 50 may mixedly include first protrusions which extend across the outer boundary of a single unit region 11 and first protrusion which extend across the outer boundary of two or more unit regions 11. Alternatively, the plurality of protrusions 50 may mixedly include the first protrusions and protrusions 50 which are located so as not to extend across the outer boundary of the unit regions 11 as viewed in plan (referred to as “second protrusions”).

### [Material of Fixing Member]

The same vibration simulations were conducted using the fixing member 60 that is made of a resin material. As for the magnitude and the maximum amplitude position, we compared a case where the material of the fixing member 60 was iron, a case where the material of the fixing member 60 was a resin material, and a case where the fixing member 60 was not provided. The Young's modulus, Poisson's ratio and density of the fixing member 60 that is made of a resin material are as shown in TABLE 7.

TABLE 7

| | Young's | | |
|---|---|---|---|
| | modulus | Poisson's | Density |
| | (GPa) | ratio | (g/cm³) |
| Fixing | 2 | 0.35 | 1.3 |
| member | | | |

The comparison results are shown in TABLE 8. As seen from TABLE 8, in the case where the fixing member 60 was made of iron, the amplification effect of the magnitude was about 3% at maximum as compared with the case where the fixing member 60 was not provided. On the other hand, it was also found that, under some conditions, the magnitude is higher when the fixing member 60 is not provided. The maximum amplitude position exhibited almost the same trend in either case.

TABLE 8

| | | | Fixing member Iron | | | | | |
|---|---|---|---|---|---|---|---|---|
| | | | (Young's modulus: 200 | | Fixing member_Resin | | Fixing member_Not | |
| Second substrate | | | GPa) | | (Young's modulus: 2 GPa) | | provided | |
| | Young's | | | Maximum | | Maximum | | Maximum |
| Thickness | modulus | | | amplitude | | amplitude | | amplitude |
| h (mm) | E (GPa) | E · h | Magnitude | position | Magnitude | position | Magnitude | position |
| 0.13 | 0.02 | 0.00 | 1.280 × 10⁻⁴ | Center | 1.279 × 10⁻⁴ | Center | 1.291 × 10⁻⁴ | Center |
| 0.13 | 0.2 | 0.03 | 1.248 × 10⁻⁴ | Center | 1.249 × 10⁻⁴ | Center | 1.267 × 10⁻⁴ | Center |
| 0.13 | 10 | 1.30 | 6.951 × 10⁻⁵ | Center | 6.933 × 10⁻⁵ | Center | 6.761 × 10⁻⁵ | Center |
| 0.13 | 20 | 2.60 | 5.999 × 10⁻⁵ | Periphery | 6.408 × 10⁻⁵ | Periphery | 7.371 × 10⁻⁵ | Periphery |
| 0.13 | 110 | 14.30 | 7.71 × 10⁻⁵ | Periphery | 8.534 × 10⁻⁵ | Periphery | 9.672 × 10⁻⁵ | Periphery |
| 0.13 | 200 | 26.00 | 7.655 × 10⁻⁵ | Periphery | 8.555 × 10⁻⁵ | Periphery | 9.618 × 10⁻⁵ | Periphery |
| 0.065 | 2 | 0.13 | 1.161 × 10⁻⁴ | Center | 1.161 × 10⁻⁴ | Center | 1.173 × 10⁻⁴ | Center |
| 0.065 | 10 | 0.65 | 8.539 × 10⁻⁵ | Center | 8.510 × 10⁻⁵ | Center | 8.406 × 10⁻⁵ | Center |
| 0.065 | 20 | 1.30 | 6.308 × 10⁻⁵ | Center | 6.287 × 10⁻⁵ | Center | 6.125 × 10⁻⁵ | Center |
| 0.065 | 40 | 2.60 | 6.113 × 10⁻⁵ | Periphery | 6.531 × 10⁻⁵ | Periphery | 7.550 × 10⁻⁵ | Periphery |
| 0.01 | 130 | 1.30 | 6.188 × 10⁻⁵ | Center | 6.169 × 10⁻⁵ | Center | 6.015 × 10⁻⁵ | Center |
| 0.01 | 260 | 2.60 | 5.917 × 10⁻⁵ | Periphery | 6.251 × 10⁻⁵ | Periphery | 7.215 × 10⁻⁵ | Periphery |

[Configuration where the Second Electrode Layer Includes a Plurality of Unit Electrodes]

In the above-described examples, the second electrode layer 30 is formed by a common electrode rather than a plurality of separate electrodes, although the configuration of the second electrode layer 30 is not limited to such examples.

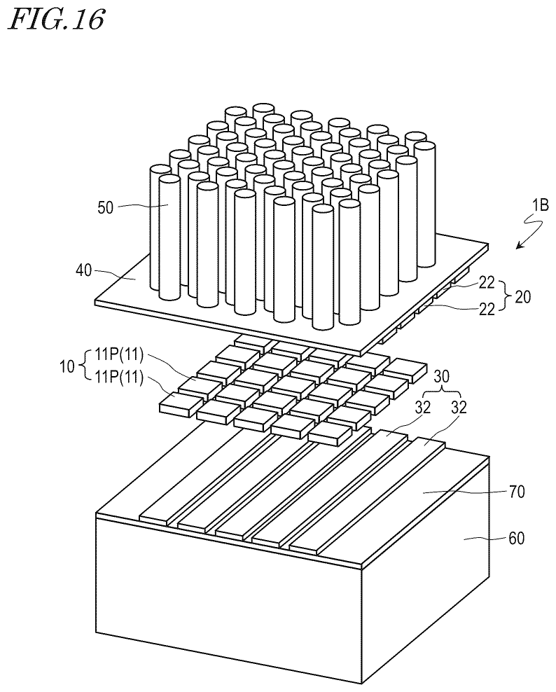

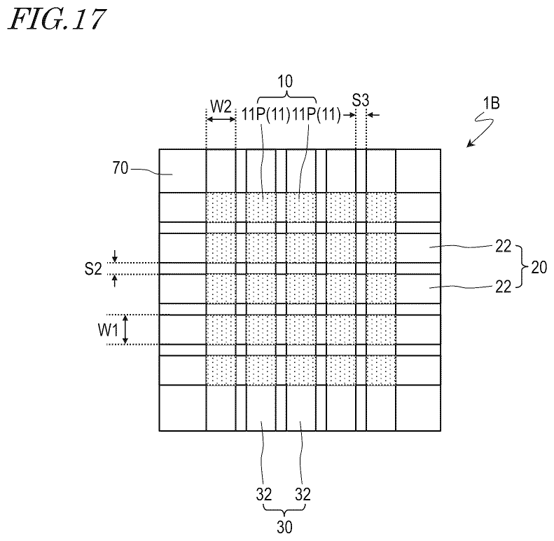

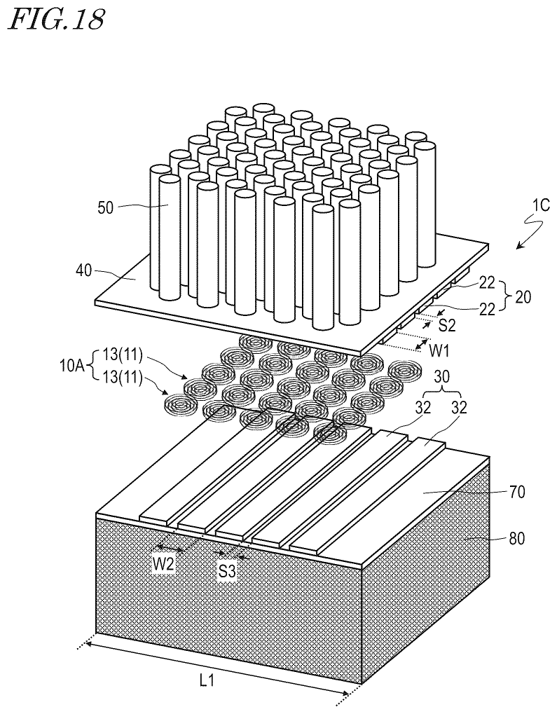

Still another tactile sensation presenting element 1B according to an embodiment of the present invention is described with reference to FIG. 15, FIG. 16 and FIG. 17. FIG. 15 and FIG. 16 are, respectively, a cross-sectional view and an exploded perspective view schematically showing the tactile sensation presenting element 1B. FIG. 17 is a plan view schematically showing the tactile sensation presenting element 1B, in which the first substrate 40 and the protrusions 50 are not shown.

In the tactile sensation presenting element 1B shown in FIG. 15, FIG. 16 and FIG. 17, the first electrode layer 20 includes a plurality of electrodes 22 that are electrically independent of one another, and the second electrode layer 30 also includes a plurality of electrodes 32 that are electrically independent of one another. Each of the plurality of electrodes 22 of the first electrode layer 20 is in the shape of a strip and elongated in a certain direction. Each of the plurality of electrodes 32 of the second electrode layer 30 is in the shape of a strip and elongated in a direction crossing (e.g., perpendicular to) the direction of elongation of the electrodes 22 of the first electrode layer 20. Hereinafter, each of the electrodes 22 of the first electrode layer 20 is referred to as “first strip electrode”, and each of the electrodes 32 of the second electrode layer 30 is referred to as “second strip electrode”.

In the tactile sensation presenting element 1B, the regions at the intersections of the first strip electrodes 22 and the second strip electrodes 32 are unit regions 11. Also, in the tactile sensation presenting element 1B, the piezoelectric layer 10 consists of a plurality of portions 11P that are separate from one another (hereinafter, referred to as “unit portions 11P”). The plurality of unit portions 11P are located in the corresponding intersection regions of the first strip electrodes 22 and the second strip electrodes 32 (i.e., in the unit regions 11).

The tactile sensation presenting element 1B was test-produced according to the specifications shown in TABLE 9, and verification of presented tactile sensations was conducted.

TABLE 9

| L1: Length of each side of | | 7.0 | mm |
|---|---|---|---|
| tactile sensation presenting element | | | |
| Piezoelectric | Material | PZT | |
| layer | Thickness | 0.19 | mm |
| Unit portions of | Area | 0.64 | mm² |
| piezoelectric | | | |
| layer | | | |
| First | Material | Copper | |
| electrode layer | Thickness | 100 | nm |
| First | Width W1 | 0.8 | mm |
| strip electrode | Gap S2 | 0.2 | mm |
| Second | Material | Copper | |
| electrode layer | Thickness | 100 | nm |
| Second | Width W2 | 0.8 | mm |
| strip electrode | Gap S3 | 0.2 | mm |
| First substrate | Material | Polyimide | |
| | Thickness | 50 | μm |
| Second substrate | Material | Polyimide | |
| | Thickness | 50 | μm |
| Fixing member | Material | Acrylic resin | |
| | T1: Thickness | 1.0 | mm |
| | of bottom | | |
| | H1: Height of | 2.0 | mm |
| | lateral wall | | |
| | H2: Total height | 3.0 | mm |
| Protrusions | Shape | Cylindrical | |
| | Material | Polyethylene | |
| | Height H | 3.0 | mm |
| | Diameter D1 | 0.5 | mm |

As shown in TABLE 9, the length of each side of the tactile sensation presenting element 1B as viewed in plan, L1, was 7.0 mm. The piezoelectric layer 10 was made of PZT, and the thickness of the piezoelectric layer 10 was 0.19 mm. The first electrode layer 20 including five first strip electrodes 22 was made of copper (Cu), and the thickness of the first electrode layer 20 was 100 nm. The width of each of the first strip electrodes 22, W1, was 0.8 mm and the gap between neighboring first strip electrodes 22, S2, was 0.2 mm. The second electrode layer 30 including five second strip electrodes 32 was made of copper (Cu), and the thickness of the second electrode layer 30 was 100 nm. The width of each of the second strip electrodes 32, W2, was 0.8 mm and the gap between neighboring second strip electrodes 32, S3, was 0.2 mm. The area of each of the intersection regions of the first strip electrodes 22 and the second strip electrodes 32 was 0.64 mm². Accordingly, the area of each of the unit portions 11P of the piezoelectric layer 10 was also 0.64 mm².

The first substrate 40 was made of polyimide, and the thickness of the first substrate 40 was 50 μm. The first substrate 40 with the first electrode layer 20 formed thereon was adhered to the piezoelectric layer 10 using an adhesive agent. The second substrate 70 was made of polyimide, and the thickness of the second substrate 70 was 50 μm. The second substrate 70 with the second electrode layer 30 formed thereon was adhered to the piezoelectric layer 10 using an adhesive agent.

The plurality of cylindrical protrusions 50 were made of polyethylene, the height of each protrusion 50, H, was 3.0 mm, and the diameter of each protrusion 50, D1, was 0.5 mm. The fixing member 60 was made of an acrylic resin. The thickness of the bottom 61 of the fixing member 60, T1, was 1.0 mm and the height of the lateral wall 62, H1, was 2.0 mm (i.e., the total height of the fixing member 60, H2, was 3.0 mm). The fixing member 60 was joined with the peripheral portion of the second substrate 70.

Predetermined signals were output to each of the first strip electrodes 22 and each of the second strip electrodes 32 of the test-produced tactile sensation presenting element 1B such that a vibration was generated. The refresh rate was 200 Hz, and the gate open time was 0.2 ms.

We evaluated presented tactile sensations with a finger F being in contact with the apex surfaces of the protrusions 50 of the test-produced tactile sensation presenting element 1B, and found that varying the output signals gave a sensation as if the materials were different. Further, the sensations were felt such that the vibration source was present at the surface of the finger F. Further, as compared with the tactile sensation presenting element 901 of Comparative Example to which the same signals were output, the tactile sensations were felt dry, and the resolution of the tactile sensations was high. That is, the vibrations were felt in a narrow range as compared with the tactile sensation presenting element 901 of Comparative Example.

Thus, similarly to the tactile sensation presenting element 1, the tactile sensation presenting element 1B can also accurately present tactile sensations in minute regions. Since in the tactile sensation presenting element 1B the piezoelectric layer 10 consists of the plurality of separate unit portions 11P, propagation of vibrations between the unit portions 11P is suppressed. Accordingly, the resolution of tactile sensations can be further increased.

Note that, unlike the previously-described configurations, a configuration may be employed in which the second electrode layer 30 includes a plurality of electrodes while the first electrode layer 20 includes a single common electrode.

[Example of Vibrator Layer Other than Piezoelectric Layer]

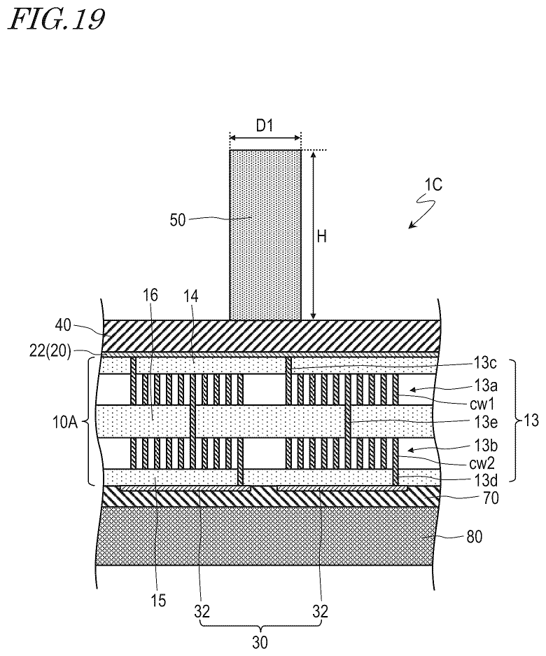

Still another tactile sensation presenting element 1C according to an embodiment of the present invention is described with reference to FIG. 18 and FIG. 19. FIG. 18 is an exploded perspective view schematically showing the tactile sensation presenting element 1C. FIG. 19 is a cross-sectional view schematically showing a part of the tactile sensation presenting element 1C.

A vibrator layer 10A included in the tactile sensation presenting element 1C shown in FIG. 18 and FIG. 19 includes a plurality of induction coils 13. The induction coils 13 are located in regions at the intersections of the first strip electrodes 22 and the second strip electrodes 32. That is, the vibrator layer 10A includes the induction coil 13 in each of the plurality of unit regions 11.

In the tactile sensation presenting element 1C, a permanent magnet 80 is provided on the rear side of the second substrate 70 (on the side opposite to the second electrode layer 30 relative to the second substrate 70), rather than the fixing member 60. The permanent magnet 80 is, for example, neodymium magnet.

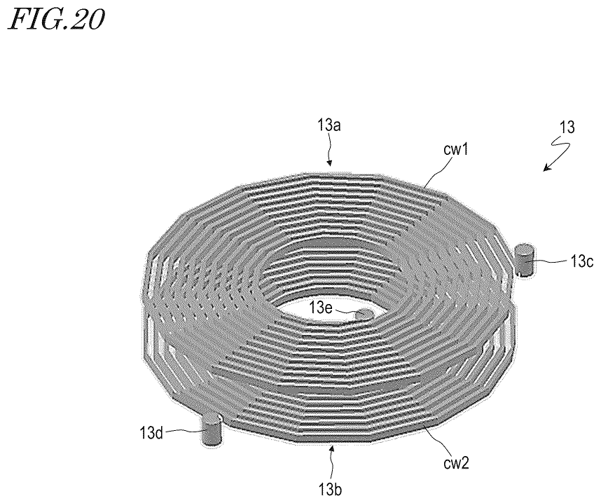

FIG. 20 is a perspective view showing an example of the induction coil 13. In the example shown in FIG. 19 and FIG. 20, the induction coil 13 includes a first coil layer 13a, a second coil layer 13b, a first contact portion 13c, a second contact portion 13d and a third contact portion 13e.

The first coil layer 13a and the second coil layer 13b are stacked up in the thickness direction of the vibrator layer 10A. Relative to the center in the thickness direction of the vibrator layer 10A, the first coil layer 13a is provided on the first electrode layer 20 side, and the second coil layer 13b is provided on the second electrode layer 30 side. Note that, in the example described herein, the induction coil 13 includes two coil layers (the first coil layer 13a and the second coil layer 13b), although the number of coil layers is not limited to two.

The first coil layer 13a is formed by a first conductive wire cw1 extending in the shape of a spiral. The number of turns of the first conductive wire cw1 is not particularly limited. A first insulating layer 14 is provided between the first coil layer 13a and the first electrode layer 20. The first coil layer 13a is electrically coupled with a corresponding one of the first strip electrodes 22 via the first contact portion 13c extending from one end of the first conductive wire cw1 to the first electrode layer 20 side.

The second coil layer 13b is formed by a second conductive wire cw2 extending in the shape of a spiral. The number of turns of the second conductive wire cw2 is not particularly limited. A second insulating layer 15 is provided between the second coil layer 13b and the second electrode layer 30. The second coil layer 13b is electrically coupled with a corresponding one of the second strip electrodes 32 via the second contact portion 13d extending from one end of the second conductive wire cw2 to the second electrode layer 30 side.

A third insulating layer 16 is provided between the first coil layer 13a and the second coil layer 13b. The first coil layer 13a and the second coil layer 13b are electrically coupled together via the third contact portion 13e extending from the other end of the first conductive wire cw1 to the other end of the second conductive wire cw2.

When an electric current is applied to the induction coil 13, electromagnetic force is produced. Attractive force and repulsive force between the induction coil 13 and the permanent magnet 80 cause deformation so that vibrations can occur in each of the unit regions 11 of the vibrator layer 10A.

The tactile sensation presenting element 1C was test-produced according to the specifications shown in TABLE 10, and verification of presented tactile sensations was conducted.

TABLE 10

| L1: Length of each side of | | 7.0 | mm |
|---|---|---|---|
| tactile sensation presenting element | | | |
| First | Material | Copper | |
| electrode layer | Thickness | 100 | nm |
| First | Width W1 | 0.8 | mm |
| strip electrode | Gap S2 | 0.2 | mm |
| Second | Material | Copper | |
| electrode layer | Thickness | 100 | nm |
| Second | Width W2 | 0.8 | mm |
| strip electrode | Gap S3 | 0.2 | mm |
| Intersection regions | Area | 0.64 | mm² |
| of first and second | | | |
| strip electrodes | | | |
| Each coil layer | Width of | 25 | μm |
| of induction coil | conductive wire | | |
| | Thickness of | 200 | nm |
| | conductive wire | | |
| | Number of turns of | 10 | |
| | conductive wire | | |
| First substrate | Material | Polyimide | |
| | Thickness | 50 | μm |
| Second substrate | Material | Polyimide | |
| | Thickness | 50 | μm |
| Protrusions | Shape | Cylindrical | |
| | Material | Polyethylene | |
| | Height H | 3.0 | mm |
| | Diameter D1 | 0.5 | mm |

| | |
|---|---|
| Permanent magnet | Neodymium magnet |

As shown in TABLE 10, the length of each side of the tactile sensation presenting element 1C as viewed in plan, L1, was 7.0 mm. The first electrode layer 20 including five first strip electrodes 22 was made of copper (Cu), and the thickness of the first electrode layer 20 was 100 nm. The width of each of the first strip electrodes 22, W1, was 0.8 mm and the gap between neighboring first strip electrodes 22, S2, was 0.2 mm. The second electrode layer 30 including five second strip electrodes 32 was made of copper (Cu), and the thickness of the second electrode layer 30 was 100 nm. The width of each of the second strip electrodes 32, W2, was 0.8 mm and the gap between neighboring second strip electrodes 32, S3, was 0.2 mm. The area of the intersection regions of the first strip electrodes 22 and the second strip electrodes 32 was 0.64 mm².

The number of coil layers in each of the induction coils 13 was two. The width and thickness of the conductive wire that forms each coil layer were 25 μm and 200 nm, respectively. The number of turns of the conductive wire in each coil layer was ten.

The first substrate 40 was made of polyimide, and the thickness of the first substrate 40 was 50 μm. The second substrate 70 was made of polyimide, and the thickness of the second substrate 70 was 50 μm. The first substrate 40 with the first electrode layer 20 formed thereon and the second substrate 70 with the second electrode layer 30 formed thereon were joined together using an adhesive agent so as to sandwich the vibrator layer 10A that includes the plurality of induction coils 13.

The plurality of cylindrical protrusions 50 was made of polyethylene, the height of each protrusion 50, H, was 3.0 mm, and the diameter of each protrusion 50, D1, was 0.5 mm. The permanent magnet 80 used was neodymium magnet.

Predetermined signals were output to each of the first strip electrodes 22 and each of the second strip electrodes 32 of the test-produced tactile sensation presenting element 1C such that a vibration was generated. The voltage of the signal wave was 1000 Vpp, the refresh rate was 200 Hz, and the gate open time was 0.2 ms.

We evaluated presented tactile sensations with a finger F being in contact with the apex surfaces of the protrusions 50 of the test-produced tactile sensation presenting element 1C and clearly felt the tactile sensations at the surface of the finger. Further, similarly to the tactile sensation presenting element 1 and other elements, the resolution of tactile sensations was high.

Thus, similarly to the tactile sensation presenting element 1 including the vibrator layer (piezoelectric layer) 10 that is made of a piezoelectric material, the tactile sensation presenting element 1C including the vibrator layer 10A that includes the induction coils 13 can also accurately present tactile sensations in minute regions.

When the piezoelectric layer 10 is used as the vibrator layer, tactile sensation sensing can be realized by detecting the variation in resistance value of the piezoelectric layer 10. Even in that case, the effect of increasing the resolution of the sensing can be achieved because the plurality of protrusions 50 are provided.

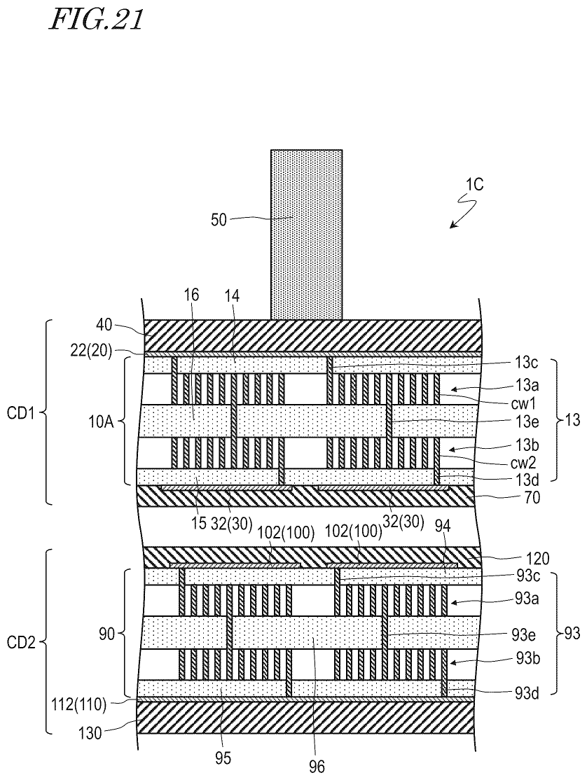

Herein, a part of the tactile sensation presenting element 1C exclusive of the protrusions 50 and the permanent magnet 80 is referred to as “coil matrix element”. The tactile sensation presenting element 1C may include another coil matrix element in place of the permanent magnet 80. FIG. 21 shows the tactile sensation presenting element 1C in which such a configuration is employed.

In the example shown in FIG. 21, the tactile sensation presenting element 1C includes a first coil matrix element CD1 and a second coil matrix element CD2.

The first coil matrix element CD1 includes a vibrator layer 10A, a first electrode layer 20, a second electrode layer 30, a first substrate 40 and a second substrate 70. The first coil matrix element CD1 is a part of the example shown in FIG. 18 and FIG. 19 exclusive of the protrusions 50 and the permanent magnet 80.

The second coil matrix element CD2 has the same structure as the first coil matrix element CD1 inverted upside down. The second coil matrix element CD2 includes a coil matrix layer 90, a third electrode layer 100, a fourth electrode layer 110, a third substrate 120 and a fourth substrate 130.

The coil matrix layer 90 includes a plurality of induction coils 93. The coil matrix layer 90 includes a plurality of regions, in each of which production of electromagnetic force can be independently controlled. In each of the regions, the induction coil 93 is provided.

The third electrode layer 100 and the fourth electrode layer 110 are located so as to oppose each other with the coil matrix layer 90 interposed therebetween. The third electrode layer 100 is located on the front side of the coil matrix layer 90 (the first coil matrix element CD1 side), and the fourth electrode layer 110 is located on the rear side of the coil matrix layer 90.

The third electrode layer 100 includes a plurality of third strip electrodes 102 elongated in a certain direction. The fourth electrode layer 110 includes a plurality of fourth strip electrodes 112 elongated in a direction crossing (e.g., perpendicular to) the direction of elongation of the third strip electrodes 102.

The induction coils 93 are located in regions at the intersections of the third strip electrodes 102 and the fourth strip electrodes 112. Similarly to the induction coils 13 of the first coil matrix element CD1, the induction coils 93 include a first coil layer 93a, a second coil layer 93b, a first contact portion 93c, a second contact portion 93d and a third contact portion 93e.

The first coil layer 93a and the second coil layer 93b are stacked up in the thickness direction of the coil matrix layer 90. The first coil layer 93a is located on the front side of the second coil layer 93b.

A fourth insulating layer 94 is provided between the first coil layer 93a and the third electrode layer 100. The first coil layer 93a is electrically coupled with a corresponding one of the third strip electrodes 102 via the first contact portion 93c.

A fifth insulating layer 95 is provided between the second coil layer 93b and the fourth electrode layer 110. The second coil layer 93b is electrically coupled with a corresponding one of the fourth strip electrodes 112 via the second contact portion 93d.

A sixth insulating layer 96 is provided between the first coil layer 93a and the second coil layer 93b. The first coil layer 93a and the second coil layer 93b are electrically coupled together via the third contact portion 93e.

In the example shown in FIG. 21, attractive force and repulsive force between the induction coils 13 of the first coil matrix element CD1 and the induction coils 93 of the second coil matrix element CD2 cause deformation so that vibrations can occur in each of the unit regions 11 of the vibrator layer 10A.

In the configuration including the permanent magnet 80 such as the example shown in FIG. 18 and FIG. 19, it is sometimes difficult to bend the tactile sensation presenting element 1C. On the other hand, in the configuration including a pair of coil matrix elements (the first coil matrix element CD1 and the second coil matrix element CD2) such as the example shown in FIG. 21, it is easy to bend the tactile sensation presenting element 1C.

Embodiments of the present invention are widely applicable to vibration type tactile sensation presenting devices that are configured to present tactile sensations by vibrational stimulation.

This application is based on Japanese Patent Application No. 2023-211528 filed on Dec. 14, 2023, the entire contents of which are hereby incorporated by reference.

What is claimed is:

1. A tactile sensation presenting element comprising:
a vibrator layer; and
a first electrode layer and a second electrode layer located so as to oppose each other with the vibrator layer interposed therebetween,
wherein at least one of the first electrode layer and the second electrode layer includes a plurality of electrodes that are electrically independent of one another,
the vibrator layer includes a plurality of unit regions, in each of which occurrence of vibration can be independently controlled, and
the tactile sensation presenting element further includes a plurality of protrusions located opposite to the vibrator layer relative to the first electrode layer.

2. The tactile sensation presenting element of claim 1, wherein the plurality of protrusions do not overlap centers of the plurality of unit regions as viewed in plan.

3. The tactile sensation presenting element of claim 1, wherein the plurality of protrusions includes at least one first protrusion located so as to extend across an outer boundary of at least one of the plurality of unit regions.

4. The tactile sensation presenting element of claim 3, wherein
the at least one first protrusion is a plurality of first protrusions,
each of the plurality of unit regions has a generally rectangular shape as viewed in plan, and
one or more of the plurality of first protrusions extend across each side of each of the plurality of unit regions as viewed in plan.

5. The tactile sensation presenting element of claim 1, further comprising a first substrate located between the first electrode layer and the plurality of protrusions, the first substrate supporting the first electrode layer.

6. The tactile sensation presenting element of claim 1, further comprising a second substrate located opposite to the vibrator layer relative to the second electrode layer, the second substrate supporting the second electrode layer,
wherein a thickness of the second substrate, h [mm], and a Young's modulus of the second substrate, E [GPa], satisfy the relationship of E·h≤1.95.

7. The tactile sensation presenting element of claim 1, wherein
each of the plurality of unit regions has a generally rectangular shape as viewed in plan, and
a height of each of the plurality of protrusions is equal to or greater than twice a length of a shortest one of sides of each of the unit regions as viewed in plan.

8. The tactile sensation presenting element of claim 1, wherein
each of the plurality of unit regions has a generally rectangular shape as viewed in plan, and
a height of each of the plurality of protrusions is equal to or greater than three times a length of a shortest one of sides of each of the unit regions as viewed in plan.

9. The tactile sensation presenting element of claim 1, wherein
a shape of a transverse cross section of each of the plurality of protrusions is substantially constant along a height direction of each protrusion, and
a cross-sectional area of the plurality of protrusions, A, and a height of each of the plurality of protrusions, H, satisfy the relationship of H≥(2·A^{0.5})/H.

10. The tactile sensation presenting element of claim 9, wherein a cross-sectional shape of each of the plurality of protrusions a generally circular shape, a generally elliptical shape, a generally rectangular shape, a generally equilateral triangular shape, or a generally equilateral convex polygonal shape.

11. The tactile sensation presenting element of claim 1, wherein a Young's modulus of each of the plurality of protrusions is equal to or smaller than 20 GPa.

12. The tactile sensation presenting element of claim 1, wherein the plurality of electrodes are a plurality of unit electrodes corresponding to the plurality of unit regions.

13. The tactile sensation presenting element of claim 12, wherein the plurality of unit electrodes are nine or more unit electrodes arrayed in m rows and n columns (m and n are each an integer equal to or greater than 3).

14. The tactile sensation presenting element of claim 1, wherein
each of the first electrode layer and the second electrode layer includes the plurality of electrodes,
the plurality of electrodes included in the first electrode layer are a plurality of first strip electrodes elongated in a predetermined direction, and
the plurality of electrodes included in the second electrode layer are a plurality of second strip electrodes elongated in a direction crossing the predetermined direction.

15. The tactile sensation presenting element of claim 1, further comprising:
a second substrate located opposite to the vibrator layer relative to the second electrode layer, the second substrate supporting the second electrode layer, the second substrate including a first region that overlaps a region including the plurality of unit regions of the vibrator layer as viewed in plan and a second region located outside the first region as viewed in plan; and
a fixing member joined with the second region of the second substrate so as to fix the second region.

16. The tactile sensation presenting element of claim 12, wherein
the first electrode layer includes the plurality of unit electrodes,
the second electrode layer includes only a single common electrode,
the common electrode includes a first region that overlaps a region including the plurality of unit regions of the vibrator layer as viewed in plan and a second region located outside the first region as viewed in plan, and
the tactile sensation presenting element further includes a fixing member joined with the second region of the common electrode so as to fix the second region.

17. The tactile sensation presenting element of claim 1, wherein the vibrator layer is a piezoelectric layer that is made of a piezoelectric material.

18. The tactile sensation presenting element of claim 17, wherein the piezoelectric layer includes a plurality of portions that are separate from one another.

19. The tactile sensation presenting element of claim 1, wherein the vibrator layer includes an induction coil in each of the plurality of unit regions.

20. The tactile sensation presenting device comprising:
the tactile sensation presenting element as set forth in claim 1; and
a control unit capable of controlling the tactile sensation presenting element.
